(19) United States
(12) Patent Application Publication
(10) Pub. No.: US 2012/0317639 A1
(43) Pub. Date: Dec. 13, 2012

(54) BIOMETRIC DATA SYSTEM

(76) Inventor: Johnson HUANG, Pingtung City (TW)

(21) Appl. No.: 13/155,441

(22) Filed: Jun. 8, 2011

(51) Int. Cl. H04L 9/32; G06F 21/00

(52) U.S. Cl. 726/19

(57) ABSTRACT

A biometric data system includes a biometric feature capture device, a front-end data display interface, a cloud operation system, databases, an identity code generation module, an identity code check module, and a result feedback module. The unique biometric features captured by the biometric feature capture device can be converted into a set of unique and unrepeated identity code through the information technique of the cloud operation system. The identity code serves to label a user's identity, whereby the identity code can be compared with the biometric features of the user to find whether the identity code matches the biometric features and verify the identity of the user.

### BACKGROUND OF THE INVENTION

1. Field of the Invention

The present invention relates generally to a method using biometric technique to create a set of unique readable identity code (characters, symbols and numerals), and more particularly an application service system combined with front-end operation and rear-end cloud operation for verifying a user's identity and access to personal information.

2. Description of the Related Art

Various biometric products have been developed and widely used in different fields. Taking a fingerprint authentication system as an example, for identity verification, the fingerprint authentication system serves to identify live bodies on the basis of the fingerprints previously stored in a computer system. The fingerprint authentication system is mainly applied to computers, communication security, credit card user identification, attendance records, etc.

It is necessary for a conventional identification system to store a great amount of biometric features and personal data. Due to the consideration of data confidence and security and the load of data transmission, this is not beneficial to mass-access Internet communication. In the case that greater amount of personal data are accessed through fingerprints, the operation duty on the server must be inevitably increased. Therefore, such kind of system is generally applied to the databases of internal networks of enterprises. Besides, incase the fingerprint features are directly computed, the amount of the feature codes or image data will be very large. This makes it uneasy to perform the computation. Also, it is hard for a user to directly read the feature codes or images.

To eliminate the above shortcomings existing in the conventional operation method, it is therefore tried by the applicant to provide a novel application system combined with a biometric feature capture device to check and compute the biometric features and search relevant personal detailed data as well as convert the biometric features into a set of unique human-readable identity code (characters, symbols and numerals).

### SUMMARY OF THE INVENTION

It is therefore a primary object of the present invention to provide a biometric data system using biometric technique to convert biometric features into a set of unique readable identity code (characters, symbols and numerals) for access to personal detailed data such as employee data, personal medical history data and examination report data. Through the cloud operation method, the problem of personal verification in time and space is solved to ensure the correctness of identity verification. The present invention also provides an application method and system to manage and control security and confidence of personal data.

The cloud application service operation system is combined with the biometric feature capture device to create a set of unique and unrepeated identity code. In operation, by means of the instruction of the front-end display interface, the existing identity code or biometric features are read. The cloud operation system serves to verify the identity code or biometric features and compare the data one-to-one or one-to-plurality by means of verification program. After the identity is verified, the personal detained data stored in the personal database is accessible through the identity code. In case no original data of a user exists, then a set of unique and unrepeated identity code is generated corresponding to the biometric features of the user. The front-end peripheral device serves to output data to a medium for later use, whereby the identity code can be directly read in the future.

The present invention can be best understood through the following description and accompanying drawings, wherein:

### BRIEF DESCRIPTION OF THE DRAWINGS

FIG. 1 is a schematic diagram of the structure of a preferred embodiment of the present invention;

FIG. 2 is a flow chart of the operation method of the present invention.

### DETAILED DESCRIPTION OF THE PREFERRED EMBODIMENTS

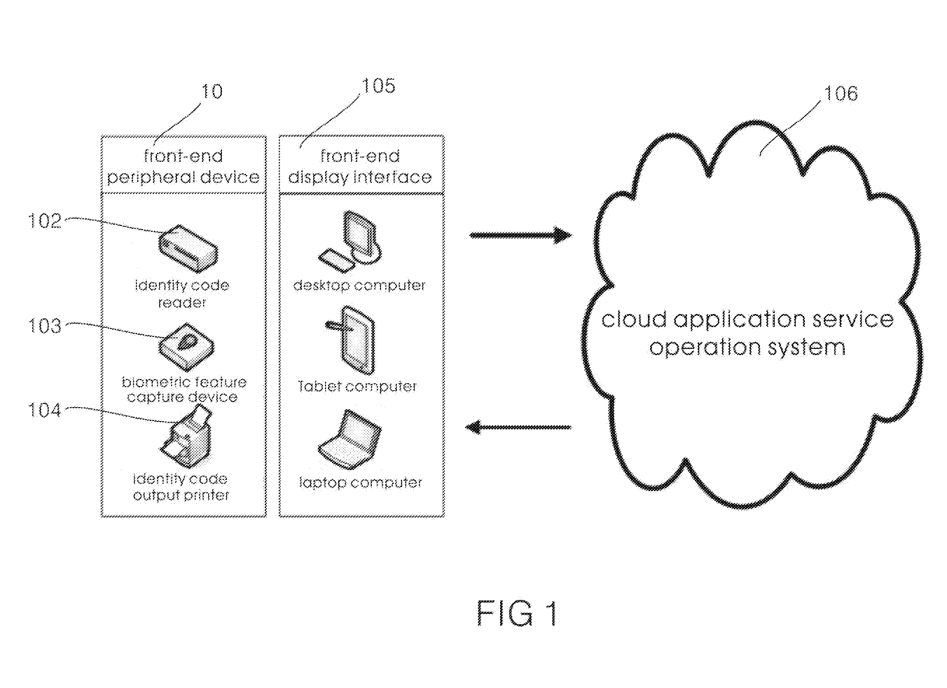

Please refer to FIG. 1. The biometric data system of the present invention includes a front-end peripheral device 10, a front-end display interface 105 and a cloud application service operation system 106. The front-end peripheral device 10 mainly includes an identity code reader 102, (which is a barcode scanner in this embodiment), a biometric feature capture device 103, (which is a fingerprint capture device in this embodiment), and an identity code output printer 104, (which is a barcode printer in this embodiment). The front-end display interface 105 can be established on different application interfaces according to the requirements of different processes, such as intelligent cellular phone, laptop computer, desktop computer, etc. The cloud application service operation system 106 includes a database for storing biometric features and identity codes, an identity code verification module 20, an identity code generation module 204, an identity code searching module 203, and a biometric feature searching module 202. The cloud application service operation system 106 is provided with different network structures and hardware structures in accordance with the requirements of service amount and data amount.

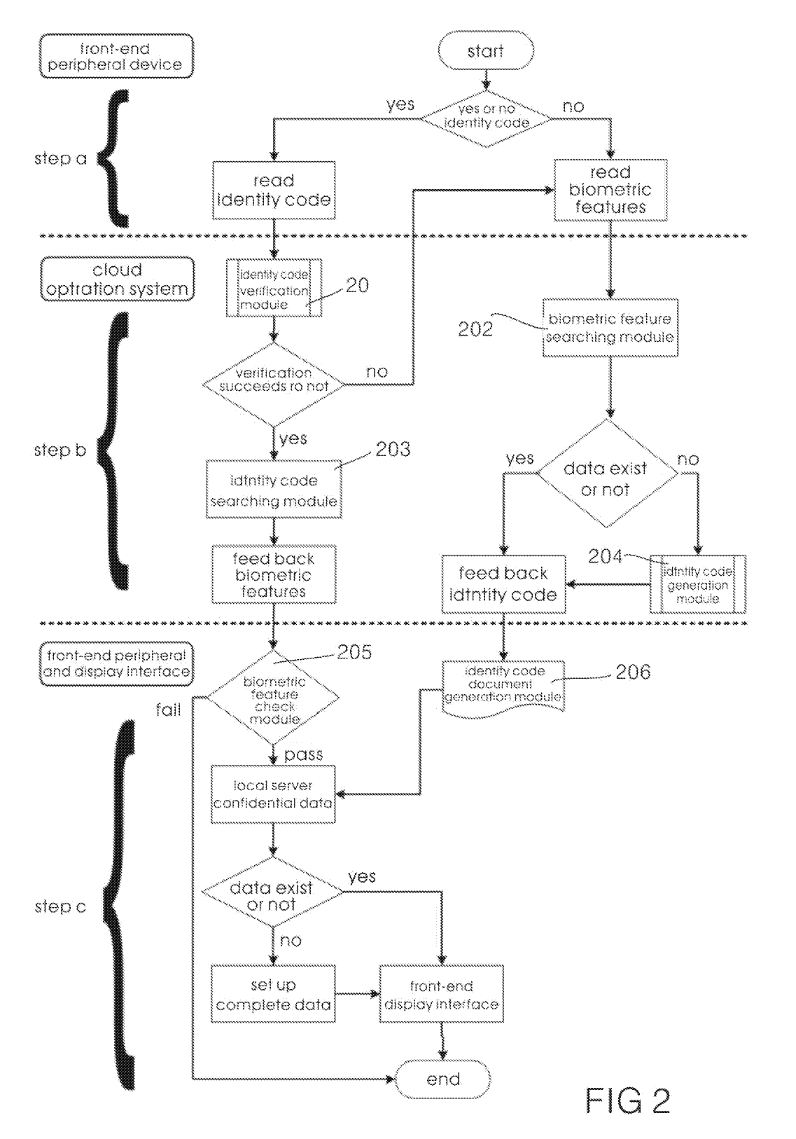

With fingerprint authentication taken as an example, the application service procedure of the present invention is as shown in FIG. 2. The procedure includes step a, step b and step c. In step a, a user first shows his/her identity code. In case there is no identity code or the identity code is missing, the fingerprint of the user is captured by means of a fingerprint capture device. In step b, the data are searched by means of the algorithm principle of the biometric feature searching module 202 of the cloud application service operation system 106. If the data have already existed, this means the identity code has been assigned to the user. In this case, the identity code data will be sent back to regenerate the identity code document for next authentication. Then, in step c, if there is no identity code, this means no file has been set up for this man yet. Under such circumstance, the identity code generation module 204 will set up an independent unrepeated identity code for this man and an identity code document generation module 206 outputs the identity code to an accessible medium (such as a paper, a card or a barcode). Finally, step c is continued.

In case of a user already having an identity code, then by means of the algorithm of the identity code verification module 20 with the check code, the set of identity code is computed to find whether the identity code meets the regulation so as to further ensure the correctness of the identity code. In case the identity code is found incorrect or damaged, it is deemed that there is no identity code and the verification is repeated through step c. On the contrary, in case that the identity code passes the verification, the data are searched by means of the algorithm principle of the identity code searching module 203 of the cloud application service operation system 106. Then, the biometric features are sent back to ask the user to one-to-one check his/her identity by means of a biometric feature check module 205 in step c. In case of failure, this means it is not the person and the procedure is directly ended. If passing the verification, the front-end display interface will ask the identity data server to access the complete personal data. If the personal data are inaccessible, this means it is a newly set identity code and the data need to be reset up. Finally, the data result is shown on the front-end display interface to end the service procedure.

The above embodiments are only used to illustrate the present invention, not intended to limit the scope thereof. Many modifications of the above embodiments can be made without departing from the spirit of the present invention.

What is claimed is:

1. A biometric data system comprising:
a front-end peripheral device for capturing unique biometric features and reading and outputting identity code, the front-end peripheral device including an identity code reader, a biometric feature capture device, and an identity code output printer, the identity code reader being connected to an identity code verification module of a cloud application service operation system;
a cloud application service operation system for searching the biometric feature identity code input from the front-end peripheral device and computing and authenticating the identity code, the cloud application service operation system including a database for storing biometric features and identity codes, an identity code verification module, an identity code generation module, an identity code searching module, and a biometric feature searching module, the identity code searching module being connected to a front-end display interface through the biometric feature searching module; and
a front-end display interface for setting the unique and unrepeated identity code converted by the cloud application service operation system on different application interfaces according to the requirements of different procedures, whereby by means of the information technique of the cloud operation system, the unique biometric features captured by the biometric feature capture device can be converted into a set of unique and unrepeated identity code, the identity code serving to label a user's identity, whereby the identity code can be compared with the biometric features of the user later to find whether the identity code matches the biometric features and verify the identity of the user for the user to access advanced confidential personal data.

2. The biometric data system as claimed in claim 1, wherein the biometric feature capture device of the front-end peripheral device is able to capture one or more biometric features for the comparison in the verification process so as to enhance the reliability of the verification.

3. The biometric data system as claimed in claim 1, wherein the identity code reader of the front-end peripheral device can be any device capable of reading characters, symbols and numerals on a medium.

4. The biometric data system as claimed in claim 1, wherein the identity code output module can be any device capable of writing characters, symbols and numerals on a medium in one-time or multiple-time memory manner, whereby the medium can provide identity code information later.

5. The biometric data system as claimed in claim 1, wherein the front-end display interface can be any visual data output device such as a screen, a cellular phone or a laptop computer, which is equipped with relevant software and hardware equipments in case operation data service is required.

6. The biometric data system as claimed in claim 1, wherein the identity code verification module includes different data base groups for verification and access to advanced data.

7. The biometric data system as claimed in claim 1, wherein the cloud application service operation system includes an identity code verification module, which is able to read the permutation and combination of the identity code and compute the correctness of the identity code according to the algorithm.

8. The biometric data system as claimed in claim 1, wherein the cloud application service operation system includes an identity code generation module for generating a regular or irregular identity code by means of relevant random algorithm, which identity code is unique and matches the biometric feature data.

9. The biometric data system as claimed in claim 1, wherein the cloud application service operation system includes an identity code searching algorithm and biometric feature searching algorithm, the algorithms including one-to-plurality or plurality-to-plurality comparison method.
